(19) United States
(12) Patent Application Publication
(10) Pub. No.: US 2024/0049136 A1
(43) Pub. Date: Feb. 8, 2024

(54) TWT TEARDOWN PROCESS FOR MULTI-LINK DEVICES

(71) Applicant: Samsung Electronics Co., Ltd., Suwon-si, Gyeonggi-do (KR)

(72) Inventors: Rubayet Shafin, Allen, TX (US); Boon Loong Ng, Plano, TX (US); Peshal Nayak, Plano, TX (US); Vishnu Vardhan Ratnam, Plano, TX (US)

(21) Appl. No.: 18/359,632

(22) Filed: Jul. 26, 2023

Related U.S. Application Data
(60) Provisional application No. 63/395,719, filed on Aug. 5, 2022.

(51) Int. Cl. H04W 52/02

(52) U.S. Cl. CPC H04W 52/0229

(57) ABSTRACT

Methods and apparatuses for facilitating target wake time (TWT) teardown operations by multi-link devices (MLDs) in a wireless local area network. A non-access point (AP) MLD comprises a processor and stations (STAs), each comprising a transceiver configured to form a link with a corresponding AP of an AP MLD, wherein at least one TWT schedule or agreement is established on at least one of the links. The processor is operably coupled to the STAs and configured to generate or interpret a first message that identifies at least one of the links and indicates that TWT teardown is to be performed for the identified at least one link. The transceiver of a first of the STAs is further configured to transmit or receive the first message to or from the AP MLD over a first of the links.

### CROSS-REFERENCE TO RELATED APPLICATION AND CLAIM OF PRIORITY

This application claims priority under 35 U.S.C. § 119(e) to U.S. Provisional Patent Application No. 63/395,719 filed on Aug. 5, 2022, which is hereby incorporated by reference in its entirety.

### TECHNICAL FIELD

This disclosure relates generally to power management in wireless communications systems that include multi-link devices. Embodiments of this disclosure relate to methods and apparatuses for enhancing Target Wake Time operations of multi-link devices in a wireless local area network communications system.

### BACKGROUND

Wireless local area network (WLAN) technology allows devices to access the internet in the 2.4 GHz, 5GHz, 6GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

Target wake time (TWT) is one of the most important features for power management in WI-FI networks, which was developed by IEEE 802.11ah and later adopted and modified into IEEE 802.11ax. With TWT operation, it suffices for a STA to only wake up at a pre-scheduled time negotiated with another STA or AP in the network. In IEEE 802.11ax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

Restricted TWT (rTWT or r-TWT) operation is a newly introduced feature in IEEE 802.11be, which provides more protection for restricted TWT scheduled STAs in order to serve latency-sensitive applications in a timely manner. Restricted TWT is based on Broadcast TWT mechanisms, however, there are some key characteristics that make restricted TWT operation an important feature for supporting low-latency applications in next generation WLAN systems. Restricted TWT offers a protected service period for its member STAs by sending Quiet elements to other STAs in the basic service set (BSS) which are not members of the rTWT schedule, where the Quiet interval corresponding to the Quiet element overlaps with the initial portion of the restricted TWT service period (SP). Hence, it gives more channel access opportunities to the rTWT member scheduled STAs, which helps latency-sensitive traffic flows.

### SUMMARY

Embodiments of the present disclosure provide methods and apparatuses for facilitating TWT teardown operations by MLDs in a WLAN.

In one embodiment, a non-AP MLD is provided, comprising STAs and a processor operably coupled to the STAs. The STAs each comprise a transceiver configured to form a link with a corresponding AP of an AP MLD. At least one TWT schedule or agreement is established on at least one of the links. The processor is configured to generate or interpret a first message that identifies at least one of the links and indicates that TWT teardown is to be performed for the identified at least one link. The transceiver of a first of the STAs is further configured to transmit or receive the first message to or from the AP MLD over a first of the links.

In another embodiment, an AP MLD is provided, comprising APs and a processor operably coupled to the APs. The APs each comprise a transceiver configured to form a link with a corresponding STA of a non-AP MLD. At least one TWT schedule or agreement is established on at least one of the links. The processor is configured to generate or interpret a first message that identifies at least one of the links and indicates that TWT teardown is to be performed for the identified at least one link. The transceiver of a first of the APs is further configured to transmit or receive the first message to or from the non-AP MLD over a first of the links.

In another embodiment, a method of wireless communication performed by a non-AP MLD that comprises STAs is provided. The STAs each comprise a transceiver configured to form a link with a corresponding AP of an AP MLD, and at least one TWT schedule or agreement is established on at least one of the links. The method comprises the steps of generating or interpreting a first message that identifies at least one of the links and indicates that TWT teardown is to be performed for the identified at least one link, and transmitting or receiving the first message to or from the AP MLD over a first of the links.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example of different timing components pertaining to a TWT SP according to embodiments of the present disclosure;

FIG. 4 illustrates an example format of the TWT Flow field according to embodiments of the present disclosure;

FIG. 5 illustrates an example format of the TWT Flow field according to embodiments of the present disclosure;

FIG. 6 illustrates an example format of the TWT Flow field according to embodiments of the present disclosure;

FIG. 7 illustrates an example format of the TWT Flow field including a Link ID bitmap according to embodiments of the present disclosure;

FIG. 8 illustrates an example format of the TWT Flow field including a Link ID bitmap according to embodiments of the present disclosure;

FIG. 9 illustrates an example format of the TWT Flow field including a Link ID bitmap according to embodiments of the present disclosure;

FIG. 10 illustrates an example of usage of a TWT Teardown frame in the context of multi-link operation according to embodiments of the present disclosure;

FIG. 11 illustrates an example format of the TWT Flow field including a Link ID subfield according to embodiments of the present disclosure;

FIG. 12 illustrates an example format of the TWT Flow field including a Link ID subfield according to embodiments of the present disclosure;

FIG. 13 illustrates an example format of the TWT Flow field including a Link ID subfield according to embodiments of the present disclosure;

FIG. 14 illustrates an example format of the TWT Flow field including a TWT schedule exclusion subfield according to embodiments of the present disclosure;

FIG. 15 illustrates an example process for usage of a TWT Teardown frame in the context of multi-link devices; and

FIGS. 16A and 16B illustrate example processes for facilitating TWT teardown operations by MLDs according to various embodiments of the present disclosure.

### DETAILED DESCRIPTION

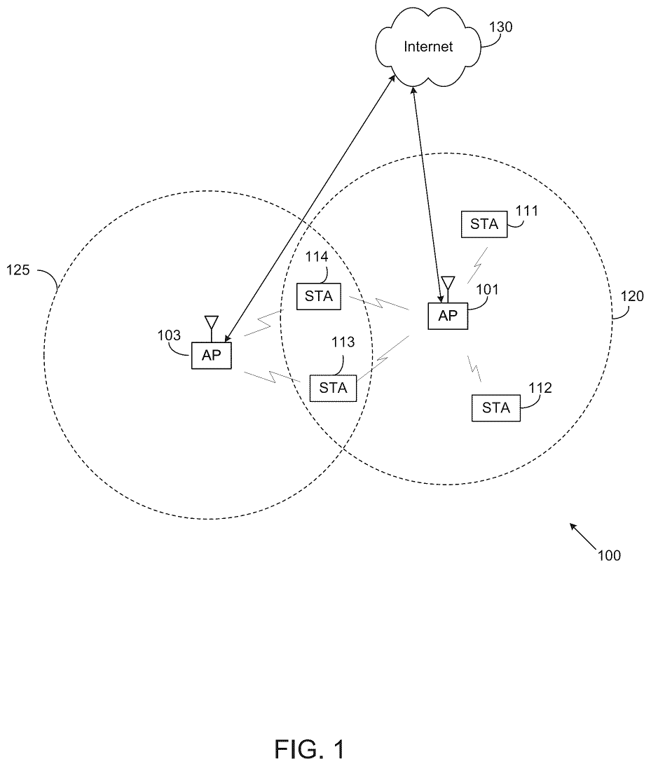

FIGS. 1 through 16B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

A TWT Teardown frame is used to teardown a TWT agreement or TWT schedule that has been established between an AP and a non-AP STA. Embodiments of the present disclosure recognize that the usage of TWT Teardown frames in multi-link operation is not defined in the current 802. 11 specification.

Accordingly, embodiments of the disclosure provide mechanisms for facilitating the use by MLDs of a TWT Teardown frame to teardown TWT schedules or agreements in multi-link operation.

Embodiments of the present disclosure further recognize that there is currently no way to exclude any particular TWT agreements or schedules from the group of schedules or agreements that are being torn down. This is not very conducive for restricted TWT operation, as an r-TWT scheduled STA can have multiple broadcast TWT schedules and restricted TWT schedules and the scheduled STA may want to tear down the broadcast TWT schedules for, e.g., power saving purposes while maintaining the r-TWT schedules for low latency traffic purposes.

Accordingly, embodiments of the disclosure provide mechanisms for facilitating selective TWT schedule exclusion from a TWT teardown process using a TWT Teardown frame.

Embodiments of the present disclosure also recognize that currently the TWT Teardown frame is a unicast frame, which cannot be transmitted to multiple STAs at the same time. An r-TWT scheduling AP affiliated with an AP MLD, for example, may want to disable a link for a certain time period, but currently there is no way to use the TWT Teardown frame to tear down all TWT schedules operating on the link before the link is disabled or deleted.

Accordingly, embodiments of the disclosure provide mechanisms for facilitating the usage of broadcast TWT Teardown frames by MLDs.

Embodiments of the present disclosure further recognize that currently the TWT Teardown frame cannot operate on an MLD level. An MLD may, for example, want to tear down TWT schedules or agreements on multiple links to save power, but there is currently no way to indicate a link or links among the multiple links between the AP MLD and the non-AP MLD for which the TWT Teardown frame is intended.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP.” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating TWT teardown operations by MLDs in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

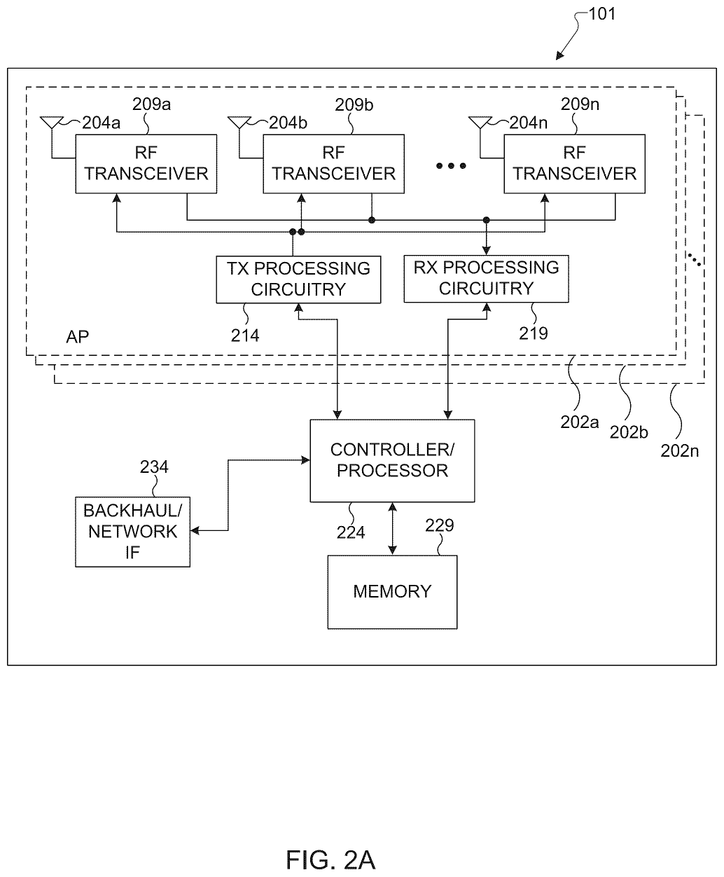

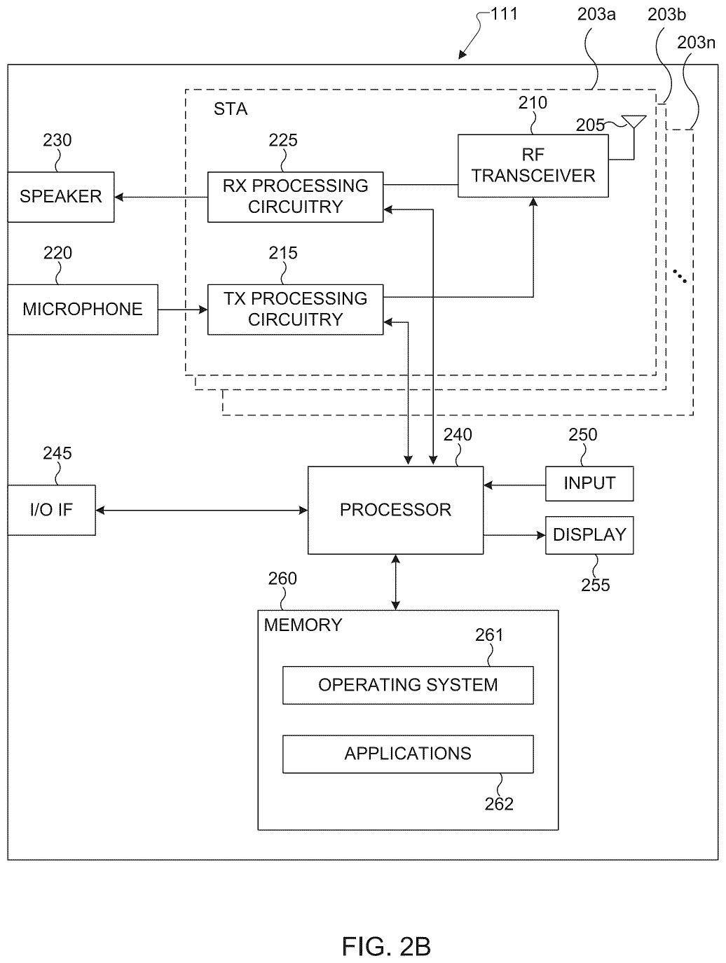

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating TWT teardown operations by MLDs in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating TWT teardown operations by MLDs in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives, from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data)

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate TWT teardown operations by MLDs in WLANs. In some embodiments, the controller/processor 240 includes at least one microprocessor or microcontroller.

The controller/processor 240 is also capable of executing other processes and programs resident in the memory 260, such as operations for facilitating TWT teardown operations by MLDs in WLANs. The controller/processor 240 can move data into or out of the memory 260 as required by an executing process. In some embodiments, the controller/processor 240 is configured to execute a plurality of applications 262, such as applications for facilitating TWT teardown operations by MLDs in WLANs. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

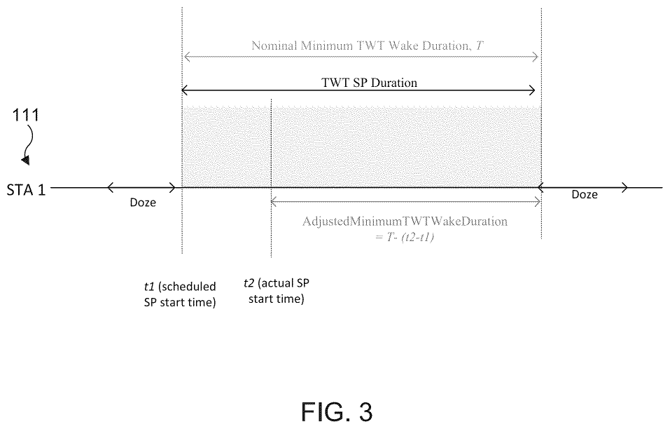

FIG. 3 illustrates an example of different timing components pertaining to a TWT SP according to embodiments of the present disclosure. In this example, STA1 may be a non-AP STA such as a STA 111. STA1 is a TWT scheduled STA and AP1 (not illustrated) is its associated TWT scheduling AP.

STA1 establishes a broadcast TWT schedule with AP1. t1 is the value of the target wake time indicated in the Target Wake Time field in the Broadcast TWT Parameter Set field of the TWT element. Hence, t1 is the time when STA1 should ideally be able to start frame exchanges with AP1. Starting from t1, the time duration the STA is required to remain awake is the value of the nominal wake time (T) indicated in the Nominal Minimum TWT Wake Duration field in the Broadcast TWT Parameter Set field. For various reasons, it may not be possible for STA1 to start frame exchanges with AP1 at the nominal SP start time, t1. The actual SP start time can be much later. In the figure, the actual SP start time is indicated as time t2. With the delayed actual SP start time, the minimum wake duration for STA1 is also adjusted and is indicated as the AdjustedMinimumTWTWakeDuration=T−(t2−t1).

As noted above, a TWT Teardown frame is used to teardown a TWT agreement or TWT schedule established between an AP and a non-AP STA. The format of the TWT Teardown frame is shown in Table 1.

TABLE 1

| Order | Information |
|---|---|
| 1 | Category |
| 2 | Unprotected S1G Action |
| 3 | TWT Flow |

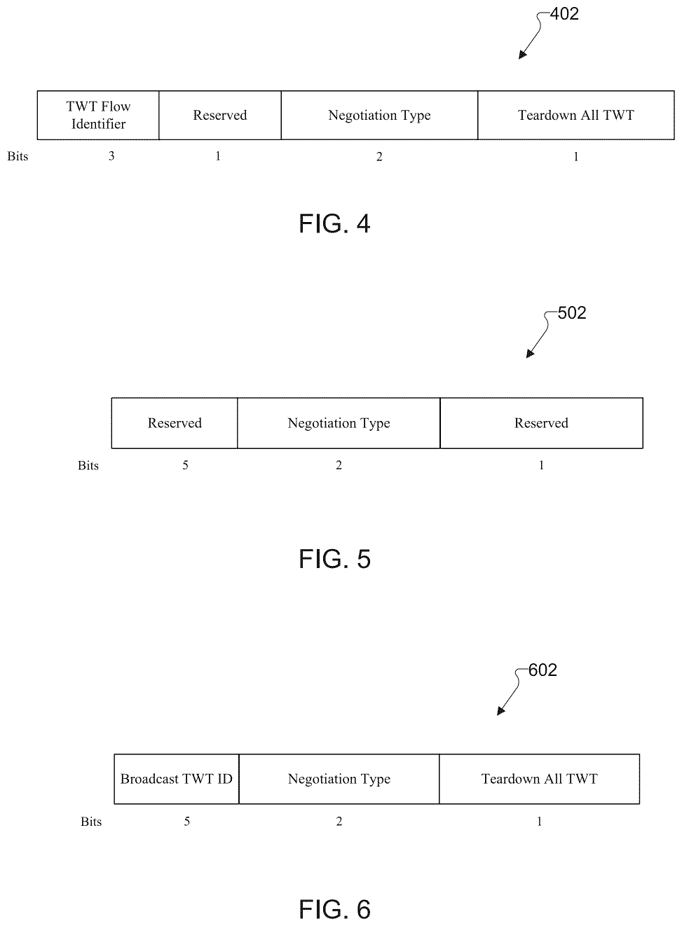

FIG. 4 illustrates an example format of the TWT Flow field 402 according to embodiments of the present disclosure. TWT Flow field 402 is an example format for the TWT Flow field in the TWT Teardown frame of Table 1 when the Negotiation Type subfield is set to 0 or 1.

FIG. 5 illustrates an example format of the TWT Flow field 502 according to embodiments of the present disclosure. TWT Flow field 502 is an example format for the TWT Flow field in the TWT Teardown frame of Table 1 when the Negotiation Type subfield is set to 2.

FIG. 6 illustrates an example format of the TWT Flow field 602 according to embodiments of the present disclosure. TWT Flow field 602 is an example format for the TWT Flow field in the TWT Teardown frame of Table 1 when the Negotiation Type subfield is set to 3.

According to one embodiment, during multi-link operation a STA affiliated with an MLD may transmit a TWT Teardown frame on a first link for tearing down a TWT agreement or schedule established on a second link. The intended link on which the TWT schedule or agreement is meant to be torn down can be indicated by including a TWT Link Identifier (ID) subfield or a TWT Link ID Bitmap subfield in the TWT Teardown frame.

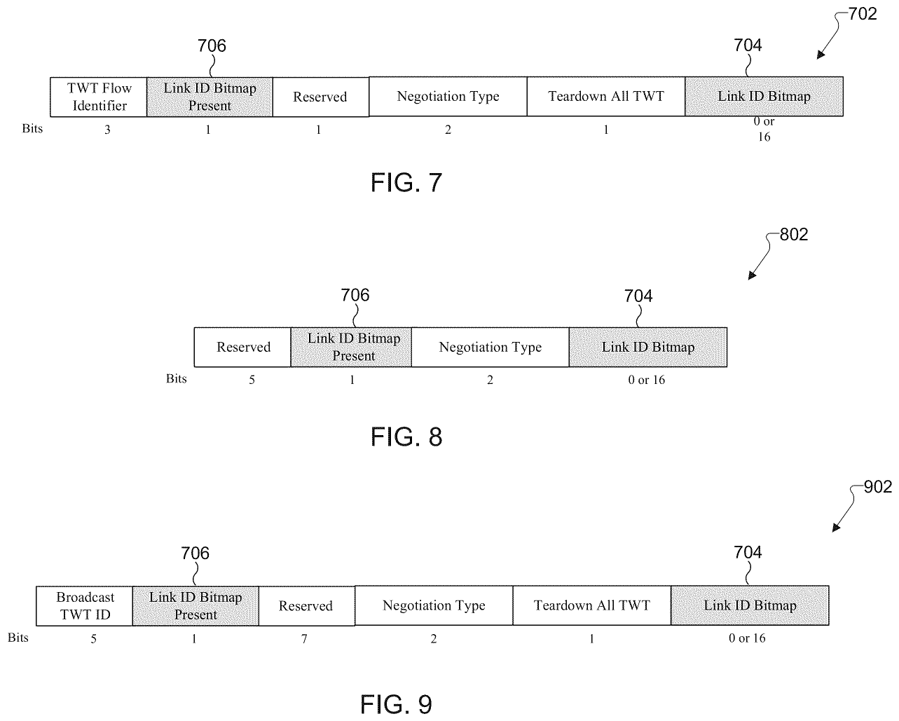

FIG. 7 illustrates an example format of the TWT Flow field 702 including a Link ID bitmap according to embodiments of the present disclosure. TWT Flow field 702 is an example format for the TWT Flow field in the TWT Teardown frame of Table 1 when the Negotiation Type subfield is set to 0 or 1. According to this embodiment, a Link ID Bitmap subfield 704 can be included in the TWT Flow field 702 of the TWT Teardown frame. According to some embodiments, there can be a Link ID Bitmap Present subfield 706 in the TWT Flow field to indicate the presence of the Link ID Bitmap subfield 704 in the TWT Flow field 702.

If the Link ID Bitmap Present subfield in the TWT Flow field is set to 1, it indicates that the Link ID Bitmap subfield is present in the TWT Flow field of the TWT Teardown frame. Otherwise, the Link ID Bitmap subfield is not present in the TWT Flow field of the TWT Teardown frame. According to one embodiment, when present in the TWT Flow field of the TWT Teardown frame, the size of the Link ID Bitmap subfield is 16 bits long. According to another embodiment, when present in the TWT Flow field, the size of the Link ID Bitmap subfield is 8 bits long.

According to some embodiments, the Link ID Bitmap subfield in the TWT Flow field of the TWT Teardown frame indicates the link or links to which the TWT Teardown frame sent by a STA affiliated with an MLD applies. A value of 1 in the bit position i of the Link ID Bitmap subfield of the TWT Flow field indicates that the link associated with the link ID i is a link to which the TWT Teardown frame sent by a STA affiliated with an MLD applies. A value of 0 in the bit position i of the Link ID Bitmap subfield of the TWT Flow field indicates that the link associated with the link ID i is not a link to which the TWT Teardown frame sent by a STA affiliated with an MLD applies.

According to one embodiment, the Link ID Bitmap subfield of the TWT Flow field can indicate at most one link. According to this embodiment, at most one bit position in the Link ID Bitmap subfield can be set to 1. According to another embodiment, the Link ID Bitmap subfield of the TWT Flow field can indicate more than one link. According to this embodiment, more than one bit position in the Link ID Bitmap subfield can be set to 1.

FIG. 8 illustrates an example format of the TWT Flow field 802 including a Link ID bitmap according to embodiments of the present disclosure. TWT Flow field 802 is an example format variation for the TWT Flow field 702 when the Negotiation Type subfield is set to 2.

FIG. 9 illustrates an example format of the TWT Flow field 902 including a Link ID bitmap according to embodiments of the present disclosure. TWT Flow field 902 is an example format variation for the TWT Flow field 702 when the Negotiation Type subfield is set to 3.

According to one embodiment, if a STA affiliated with an MLD sends a TWT Teardown frame that doesn't include a Link ID Bitmap subfield in the TWT Flow field, then it can indicate that the TWT Teardown frame applies to the link on which the TWT Teardown frame is sent.

According to one embodiment, an all-zero value in the Link ID Bitmap subfield in the TWT Flow field is reserved. According to another embodiment, an all-zero value in the Link ID Bitmap subfield in the TWT Flow field of the TWT Teardown frame indicates that the TWT Teardown frame applies to the link on which the TWT Teardown frame is sent.

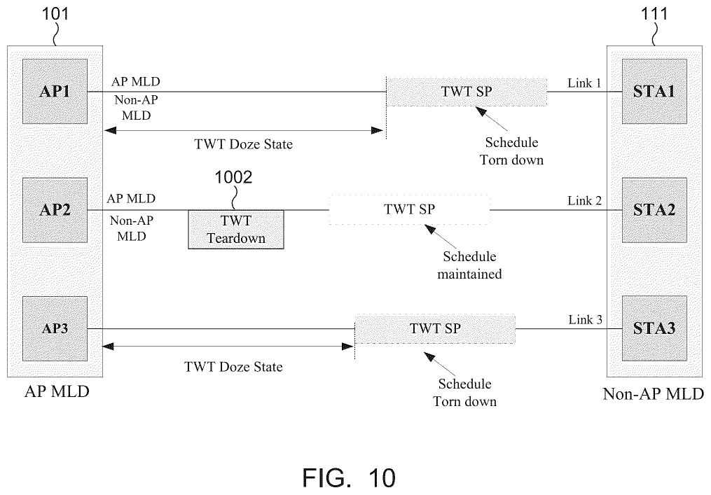

FIG. 10 illustrates an example of usage of a TWT Teardown frame in the context of multi-link operation according to embodiments of the present disclosure. In the example of FIG. 10 the AP MLD may be an AP MLD 101 and the non-AP MLD may be a non-AP MLD 111. It is understood that further references to an AP MLD or non-AP MLD herein refer to an AP MLD 101 or non-AP MLD 111, respectively. Although the AP MLD 101 is illustrated with three affiliated APs-AP1, AP2, and AP3- and non-AP MLD 111 is illustrated with three affiliated STAs-STA1, STA2, and STA3- it is understood that this is just an example, and any appropriate MLDs with any number of affiliated APs or STAs may be used.

In this example, three links are established between an AP MLD and its associated non-AP MLD-Link 1 between AP1 and STA1, Link 2 between AP2 and STA2, and Link 3 between AP3 and STA3. Three TWT schedules or agreements are set up. TWT schedule 1 is established on Link 1, TWT schedule 2 is established on Link 2, and TWT schedule 3 is established on Link 3. STA2 affiliated with the non-AP MLD sends a TWT Teardown frame 1002 to AP2 affiliated with the AP MLD over Link 2. In the TWT Teardown frame 1002, STA2 indicates Link 1 and Link 3. Hence, TWT schedule 1 and TWT schedule 3 on Link 1 and Link 3, respectively, are torn down, while schedule 2 on Link 2 is maintained.

According to one embodiment, if multiple links are indicated in the Link ID Bitmap subfield of the TWT Flow field of a TWT Teardown frame, then the Broadcast TWT ID subfield or the TWT Flow Identifier subfield of the TWT Flow field is reserved. According to another embodiment, if multiple links are indicated in the Link ID Bitmap subfield, then the TWT Teardown frame applies to the TWT schedule or agreement, as indicated by the Broadcast TWT ID subfield or the TWT Flow Identifier subfield, on the links that are indicated in the Link ID Bitmap subfield.

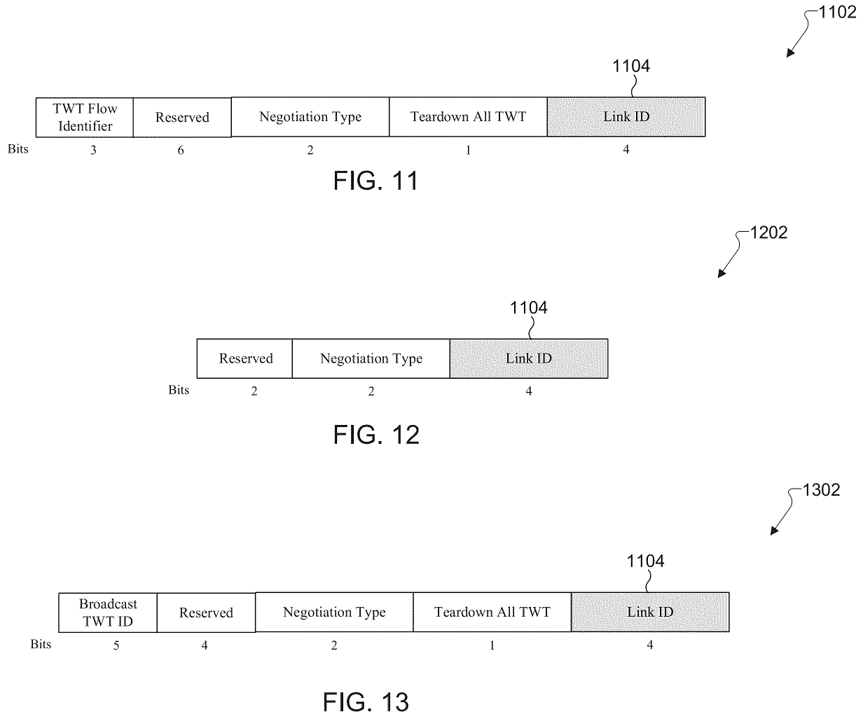

FIG. 11 illustrates an example format of the TWT Flow field 1102 including a Link ID subfield according to embodiments of the present disclosure. TWT Flow field 1102 is an example format for the TWT Flow field in the TWT Teardown frame of Table 1 when the Negotiation Type subfield is set to 0 or 1. According to this embodiment, a Link ID subfield 1104 can be included in the TWT Flow field 1102 of the TWT Teardown frame in order to indicate a link to which the TWT Teardown frame applies.

FIG. 12 illustrates an example format of the TWT Flow field 1202 including a Link ID subfield according to embodiments of the present disclosure. TWT Flow field 1202 is an example format variation for the TWT Flow field 1102 when the Negotiation Type subfield is set to 2.

FIG. 13 illustrates an example format of the TWT Flow field 1302 including a Link ID subfield according to embodiments of the present disclosure. TWT Flow field 1302 is an example format variation for the TWT Flow field 1102 when the Negotiation Type subfield is set to 3.

As noted above, there is currently no way to exclude any particular TWT agreements or schedules from the group of schedules or agreements that are being torn down using the TWT Teardown frame. For example, when the Teardown All TWT subfield is set to 1 in the TWT Flow field of the TWT Teardown frame, it indicates that all individual TWT agreements or broadcast TWT schedules are to be torn down by the TWT Teardown frame.

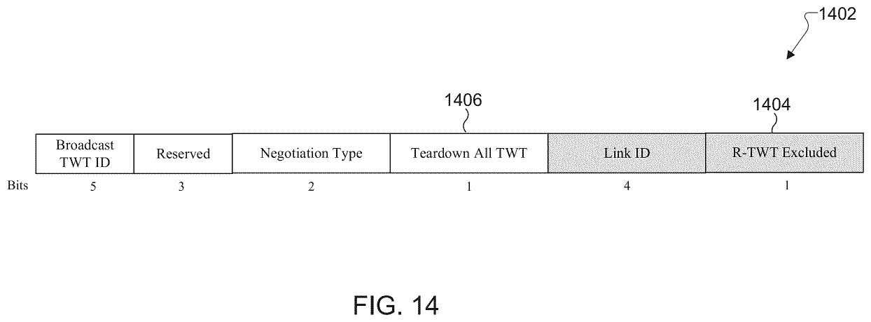

FIG. 14 illustrates an example format of the TWT Flow field 1402 including a TWT schedule exclusion subfield according to embodiments of the present disclosure. TWT Flow field 1402 is an example format for the TWT Flow field in the TWT Teardown frame of Table 1 when the Negotiation Type subfield is set to 3. According to this embodiment, an R-TWT Excluded subfield 1404 can be included in the TWT Flow field 1402 of the TWT Teardown frame in order to facilitate an indication that restricted TWT schedules are not to be torn down by the TWT Teardown frame.

The size of the R-TWT Excluded subfield 1404 can be 1 bit. If the Teardown All TWT subfield 1406 in the TWT Flow field is set to 1, and R-TWT Excluded subfield 1404 is set to 0, then it can indicates that all TWT schedules or TWT agreements on the identified link are intended to be torn down including the restricted TWT schedules. If the Teardown All TWT subfield 1406 in the TWT Flow field is set to 1, and R-TWT Excluded subfield 1404 is set to 1, then it indicates that all TWT schedules or TWT agreements on the identified link are intended to be torn except for the R-TWT schedules.

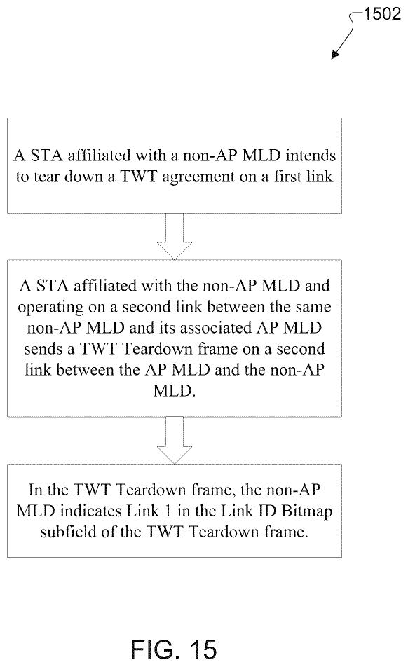

FIG. 15 illustrates an example process 1502 for usage of a TWT Teardown frame in the context of multi-link devices. In this example, a non-AP MLD has established at least two links between its affiliated STAs and corresponding APs affiliated with an associated AP MLD. The non-AP MLD transmits a TWT Teardown frame on one of the links (the second link) to tear down a TWT schedule or agreement on a different link (the first link).

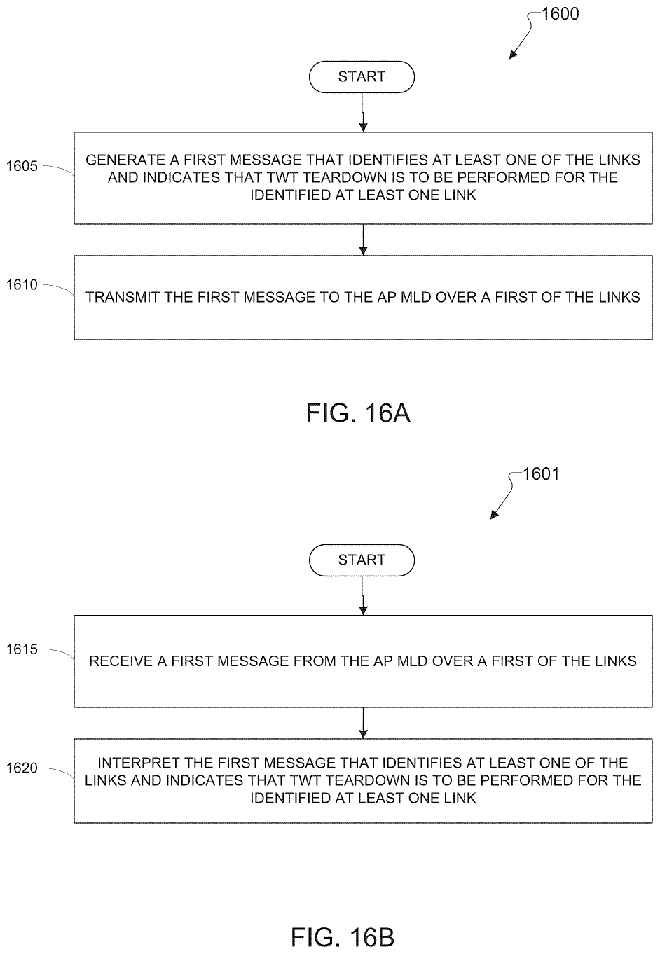

FIGS. 16A and 16B illustrate example processes for facilitating TWT teardown operations by MLDs according to various embodiments of the present disclosure. The processes 1600 and 1601 of FIGS. 16A and 16B, respectively, are discussed as being performed by a non-AP MLD, but it is understood that a corresponding AP MLD performs corresponding processes. Additionally, for convenience the processes of FIGS. 16A and 16B are discussed as being performed by a WI-FI non-AP MLD comprising a plurality of STAs that each comprise a transceiver configured to configured to form a link with a corresponding AP affiliated with a WI-FI AP MLD. However, it is understood that any suitable wireless communication device could perform these processes.

Referring to FIG. 16A, the process 1600 begins with the non-AP MLD generating a first message that identifies at least one of the links and indicates that TWT teardown is to be performed for the identified at least one link (step 1605). In some embodiments, the first message is a TWT Teardown frame that includes a TWT Flow field that identifies the at least one link.

The non-AP MLD then transmits the first message to the AP MLD over a first of the links (step 1610).

In some embodiments, the identified at least one link includes at least one link other than the first link. That is, the first message is sent over one link to tear down TWT schedules or agreements on other links. In some embodiments, the identified at least one link may also include the first link (that is, the link on which the first message is sent).

In some embodiments, to identify the at least one link for which TWT teardown is to be performed, the non-AP MLD may include in the first message a bitmap that has entries corresponding to link identifiers for each of the links, and may set the entries of the bitmap during generation of the first message to identify the at least one link for which the TWT teardown is to be performed.

In other embodiments, to identify one link for which TWT teardown is to be performed, the non-AP MLD may include in the first message a link identifier subfield, and may set the link identifier subfield during generation of the first message to identify the one link for which the TWT teardown is to be performed.

In some embodiments, the first message includes an indication that at least one type of TWT schedule or agreement is excluded from the TWT teardown on the identified at least one link. This may be, for example, an indication that restricted TWT schedules are excluded from the TWT teardown.

Referring now to FIG. 16B, the process 1601 begins with the non-AP MLD receiving a first message from the AP MLD over a first of the links (step 1615).

The non-AP MLD then interprets the first message, which identifies at least one of the links and indicates that TWT teardown is to be performed for the identified at least one link (step 1620). As in FIG. 16A, the first message may be a TWT Teardown frame that includes a TWT Flow field that identifies the at least one link.

As in FIG. 16A, in some embodiments the identified at least one link includes at least one link other than the first link. That is, the first message is sent over one link to tear down TWT schedules or agreements on other links. In some embodiments, the identified at least one link may also include the first link (that is, the link on which the first message is sent).

Similar to FIG. 16A, in some embodiments the first message may include a bitmap that has entries corresponding to link identifiers for each of the links, and the non-AP MLD may interpret the entries of the bitmap after reception of the first message to identify the at least one link for which the TWT teardown is to be performed.

Similar to FIG. 16A, in some embodiments the first message may include a link identifier subfield, and the non-AP MLD may interpret the link identifier subfield after reception of the first message to identify the one link for which the TWT teardown is to be performed.

As in FIG. 16A, in some embodiments the first message includes an indication that at least one type of TWT schedule or agreement is excluded from the TWT teardown on the identified at least one link. This may be, for example, an indication that restricted TWT schedules are excluded from the TWT teardown.

The above flowcharts illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope The scope of patented subject matter is defined by the claims

What is claimed is:

1. A non-access point (AP) multi-link device (MLD) comprising:
stations (STAs) each comprising a transceiver configured to form a link with a corresponding AP of an AP MLD, wherein at least one target wake time (TWT) schedule or agreement is established on at least one of the links; and
a processor operably coupled to the STAs, the processor configured to generate or interpret a first message that identifies at least one of the links and indicates that TWT teardown is to be performed for the identified at least one link,
wherein the transceiver of a first of the STAs is further configured to transmit or receive the first message to or from the AP MLD over a first of the links.

2. The non-AP MLD of claim 1, wherein the identified at least one link includes at least one link other than the first link.

3. The non-AP MLD of claim 1, wherein:
the first message includes a bitmap that has entries corresponding to link identifiers for each of the links, and
the processor is further configured to:
set the entries of the bitmap during generation of the first message to identify the at least one link for which the TWT teardown is to be performed; or
interpret the entries of the bitmap after reception of the first message to identify the at least one link for which the TWT teardown is to be performed.

4. The non-AP MLD of claim 1, wherein:
the first message includes a link identifier subfield, and
the processor is further configured to:
set the link identifier subfield during generation of the first message to identify one link for which the TWT teardown is to be performed; or
interpret the link identifier subfield after reception of the first message to identify the one link for which the TWT teardown is to be performed.

5. The non-AP MLD of claim 1, wherein the first message includes an indication that at least one type of TWT schedule or agreement is excluded from the TWT teardown on the identified at least one link.

6. The non-AP MLD of claim 5, wherein the indication that at least one type of TWT schedule or agreement is excluded from the TWT teardown is an indication that restricted TWT schedules are excluded from the TWT teardown.

7. The non-AP MLD of claim 1, wherein the first message is a TWT Teardown frame that includes a TWT Flow field that identifies the at least one link.

8. An access point (AP) multi-link device (MLD), comprising:
APs each comprising a transceiver configured to form a link with a corresponding station (STA) of a non-AP MLD, wherein at least one target wake time (TWT) schedule or agreement is established on at least one of the links; and
a processor operably coupled to the APs, the processor configured to generate or interpret a first message that identifies at least one of the links and indicates that TWT teardown is to be performed for the identified at least one link,
wherein the transceiver of a first of the APs is further configured to transmit or receive the first message to or from the non-AP MLD over a first of the links.

9. The AP MLD of claim 8, wherein the identified at least one link includes at least one link other than the first link.

10. The AP MILD of claim 8, wherein:
the first message includes a bitmap that has entries corresponding to link identifiers for each of the links, and
the processor is further configured to:
set the entries of the bitmap during generation of the first message to identify the at least one link for which the TWT teardown is to be performed; or
interpret the entries of the bitmap after reception of the first message to identify the at least one link for which the TWT teardown is to be performed.

11. The AP MLD of claim 8, wherein:
the first message includes a link identifier subfield, and
the processor is further configured to:
set the link identifier subfield during generation of the first message to identify one link for which the TWT teardown is to be performed; or
interpret the link identifier subfield after reception of the first message to identify the one link for which the TWT teardown is to be performed.

12. The AP MLD of claim 8, wherein the first message includes an indication that at least one type of TWT schedule or agreement is excluded from the TWT teardown on the identified at least one link.

13. The AP MLD of claim 12, wherein the indication that at least one type of TWT schedule or agreement is excluded from the TWT teardown is an indication that restricted TWT schedules are excluded from the TWT teardown.

14. The AP MLD of claim 8, wherein the first message is a TWT Teardown frame that includes a TWT Flow field that identifies the at least one link.

15. A method of wireless communication performed by a non-access point (AP) multi-link device (MLD) that comprises stations (STAs) that each comprise a transceiver configured to form a link with a corresponding AP of an AP MLD, wherein at least one target wake time (TWT) schedule or agreement is established on at least one of the links, the method comprising:
generating or interpreting a first message that identifies at least one of the links and indicates that TWT teardown is to be performed for the identified at least one link; and
transmitting or receiving the first message to or from the AP MLD over a first of the links.

16. The method of claim 15, wherein the identified at least one link includes at least one link other than the first link.

17. The method of claim 15, wherein:
the first message includes a bitmap that has entries corresponding to link identifiers for each of the links, and
the method further comprises:
setting the entries of the bitmap during generation of the first message to identify the at least one link for which the TWT teardown is to be performed; or
interpreting the entries of the bitmap after reception of the first message to identify the at least one link for which the TWT teardown is to be performed.

18. The method of claim 15, wherein:
the first message includes a link identifier subfield, and
the method further comprises:
setting the link identifier subfield during generation of the first message to identify one link for which the TWT teardown is to be performed; or
interpreting the link identifier subfield after reception of the first message to identify the one link for which the TWT teardown is to be performed.

19. The method of claim 15, wherein the first message includes an indication that at least one type of TWT schedule or agreement is excluded from the TWT teardown on the identified at least one link.

20. The method of claim 19, wherein the indication that at least one type of TWT schedule or agreement is excluded from the TWT teardown is an indication that restricted TWT schedules are excluded from the TWT teardown.
